(19) United States
(12) Patent Application Publication
(10) Pub. No.: US 2010/0225733 A1
(43) Pub. Date: Sep. 9, 2010

(54) Systems and Methods for Managing Virtual Collaboration Systems

(75) Inventors: Ted W. Beers, Corvallis, OR (US); Scott Grasley, Lebanon, OR (US); Dirk Hogan, Corvallis, OR (US); Richard N. McKay, Corvallis, OR (US); David H. Ochs, Corvallis, OR (US); Linda Godwin, Corvallis, OR (US); Deqing Hu, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Packard Development Company, Houston, TX (US)

(21) Appl. No.: 11/917,716

(22) PCT Filed: Oct. 1, 2007
(86) PCT No.: PCT/US07/80091

§ 371 Date: Oct. 20, 2009

(51) Int. Cl. H04N 7/14

(52) U.S. Cl. 348/14.08; 348/E07.077

(57) ABSTRACT

Systems and methods for managing virtual collaboration systems are disclosed herein. A virtual collaboration system includes a hoster configured to receive second media streams from at least a second node, and to transmit those streams from at least one simulated node to at least a first node; and a management subsystem adapted to dynamically configure a topology of a virtual collaborative event, wherein configuration of the topology includes a determination of media stream connections among the at least one simulated node and the at least a first node based on at least one policy, and wherein the media stream connections establish and maintain virtual relationships among the at least one simulated node and the at least a first node.

### BACKGROUND

Videoconferencing and other forms of virtual collaboration allow the real-time exchange of video, audio, and/or other data among systems in remote locations. That real-time exchange of data often occurs over a computer network in the form of streaming video and/or audio data. Many systems can establish media streams at the beginning of an event, but cannot transition smoothly to new configurations as various systems enter and/or leave an event.

Additionally, numerous methods have been devised to connect systems with identical or substantially compatible capabilities. However, managing events involving systems with differing capabilities and/or systems connected to different networks is substantially more difficult. For example, few existing methods for event configuration adequately negotiate media connections among heterogeneous systems and/or heterogeneous networks. Those systems that require user input to establish connections detract from the collaborative experience. Other systems may establish connections automatically, but base media support on sometimes erroneous assumptions of the capabilities of participating systems.

One established protocol, Session Initiation Protocol (SIP), allows systems to negotiate media connections among multiple devices. However, SIP does not consider the relationships among media streams in order to maintain virtual relationships among participants. Moreover, SIP does not communicate the availability of advanced capabilities that would support optimal media connections. Current virtual collaboration systems do not adequately support systems with varying levels of functionality and/or allow dynamic reconfiguration of participating systems without interruption of an event in progress. They also lack support for the establishment of consistent virtual relationships among participating systems, such as participating systems that have different capabilities and/or that are connected to different networks. Additionally, they do not allow subdivision of resources within a system participating in a virtual collaboration event. Moreover, current virtual collaboration systems do not allow representation of one or more systems connected to one network, as one or more virtual systems connected to a different network.

### BRIEF DESCRIPTION OF THE DRAWINGS

The accompanying drawings illustrate various examples of the present systems and methods and are a part of the disclosure. The illustrated examples are merely examples of the present systems and methods and do not limit the scope of the disclosure.

FIG. 1 is a block diagram of an event manager system, according to some embodiments.

FIG. 2 is a block diagram of a node, according to some embodiments.

FIG. 3 is a block diagram of a hoster, according to some embodiments.

FIG. 4 is a block diagram of a hoster, according to other embodiments.

FIG. 5 is a block diagram of an event focus, according to some embodiments.

FIG. 6 is a block diagram of an event manager, according to some embodiments.

FIG. 7 is a block diagram of a sequence of connections established as a node joins a collaborative event, according to some embodiments.

FIGS. 8A through 8D are schematics of virtual relationships for collaborative events involving three or four nodes, according to various illustrative examples.

FIGS. 9A through 9D illustrate media streams transmitted and received during collaborative events involving three or four nodes, according to various illustrative examples.

FIG. 10 is a flow chart of a method of operation of a manager of a node and/or a hoster, according to some embodiments.

FIG. 11 is a flow chart of a method of operation of an event focus, according to some embodiments.

FIG. 12 is a flow chart of a method of operation of an event manager, according to some embodiments.

Throughout the drawings, identical reference numbers may designate similar, but not necessarily identical, elements.

### DETAILED DESCRIPTION

The present illustrative methods and systems may be adapted to manage the configuration of virtual collaboration systems, such as virtual collaboration systems that involve nodes that have different capabilities and/or that are connected to different networks. Specifically, the present illustrative systems and methods may, among other things, intrinsically consider the relationships among related media streams, manage and maintain the virtual relationships among nodes to optimize the directives to the nodes to support a new topology, support a variety of proprietary and industry-standard communications mechanisms while managing one or more of the nodes equivalently in the event itself, and/or subdivide resources within one or more of the participating nodes. Further details of the present illustrative virtual collaboration systems and methods will be provided below.

As used in the present disclosure and in the appended claims, the term “media” is defined to include text, video, sound, images, data, and/or any other information that may be transmitted over a computer network.

Additionally, as used in the present disclosure and in the appended claims, the term “node” is defined to include any system with one or more components configured to receive, present, and/or transmit media with a remote system directly and/or through a network. Suitable node systems may include videoconferencing studio(s), computer system(s), notebook computer(s), telephone(s), personal digital assistant(s) (PDAs), or any combination of the previously mentioned or similar devices. A node may be a physical node or a simulated node. Unless specified as the former or the latter, the term “node” refers to either or both.

Physical nodes include one or more components that are independent from the components of a host system or hoster, and are configured to receive, present, and/or transmit media with a remote system directly and/or through a network. In contrast, simulated nodes include one or more components that are associated with and/or part of a host system or hoster. Those components of the hoster are configured to receive, present, and/or transmit media with a remote system directly and/or through a network.

In some embodiments, one or more components of the virtual collaboration system and/or other nodes interact with the simulated nodes as if those simulated nodes were separate from the hoster and/or included their own components independent of the hoster. In other words, from the perspective of the physical nodes and one or more components of the virtual collaboration system, the simulated nodes may receive, generate, and/or transmit signals and/or media streams even though a host system or hoster is physically receiving, generating, and/or transmitting those signals and/or streams. In some embodiments, the virtual collaboration system and/or other nodes interact with the simulated nodes with the recognition that those simulated nodes depend on the components of a hoster.

Similarly, as used in the present disclosure and in the appended claims, the term “event” is defined to include any designated time and/or virtual meeting place providing systems a framework to exchange information. An event allows at least one node to transmit and receive media information and/or media streams. According to some embodiments, the event exists separate and distinct from nodes participating in collaboration. Further, an event may exist while nodes are exchanging information and also may exist while no nodes are participating, such as before any nodes have joined an event. An event also may be referred to as a “session.”

Further, as used in the present disclosure and in the appended claims, the term “topology” is defined to include each system associated with an event and its respective configuration, state, and/or relationship to other systems associated with the event. A topology may include node(s), hoster(s), event focus(es), event manager(s), virtual relationships among nodes, mode of participation of the node(s) and/or the hoster(s), and/or media streams associated with the event.

Moreover, as used in the present illustrative disclosure, the terms “subsystem” and “module” may be used interchangeably to include any number of hardware, software, firmware components, or any combination thereof. As used in the present disclosure, the subsystems and modules may be a part of and/or hosted by one or more computing devices, including server(s), personal computer(s), personal digital assistant(s), and/or any other processor containing apparatus. Various subsystems and modules may perform differing functions and/or roles and together may remain a single unit, program, device, and/or system.

In the following description, numerous specific details are set forth in order to provide a thorough understanding of the present systems and methods. It will be apparent, however, to one skilled in the art that the present systems and methods may be practiced without these specific details. Reference in the disclosure to “one example” or “an example” means that a particular feature, structure, and/or characteristic described in connection with the example is included in at least one example. The appearance of the phrase “in one example” in various places in the disclosure are not necessarily all referring to the same example.

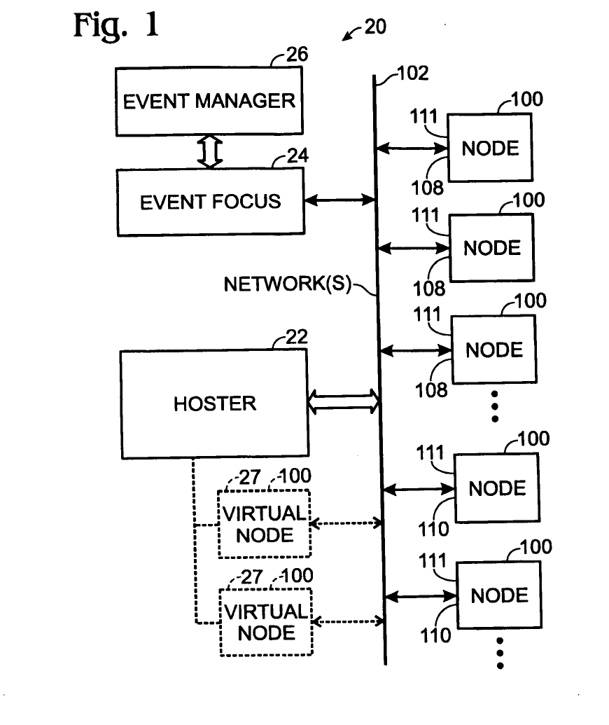

FIG. 1 shows a management subsystem or an event manager system 20, according to some embodiments. As used herein, and in the appended claims the terms “management subsystem” and “event manager system” may be used interchangeably. Event manager system 20 may include any suitable structure used to provide and/or manage one or more collaborative “cross-connected” events among nodes 100 communicatively coupled to the event manager system via one or more communication networks 102. For example, the event manager system may include at least one hoster 22, an event focus 24, and an event manager 26.

As illustrated in FIG. 1, collaborative event participating subsystems or nodes 100 may be communicatively coupled to event manager system 20 via one or more networks 102, such as a first network and/or a second network. Nodes 100 may include one or more first nodes 108 and one or more second nodes 110. First nodes 108 may be communicatively coupled to any suitable network(s) and may include physical node(s) and/or simulated node(s). The first nodes that are physical nodes may be referred to as “first physical nodes,” while the first nodes that are simulated nodes may be referred to as “first simulated nodes.”

Second nodes 110 may be communicatively coupled to any suitable network(s) and may include physical node(s) and/or simulated node(s). The second nodes that are physical nodes may be referred to as “second physical nodes,” while the second nodes that are simulated nodes may be referred to as “second simulated nodes.” Although three of first nodes 108 and two of second nodes 110 are shown, any suitable number of first and/or second nodes may be communicatively coupled to the event manager system. In some embodiments, first nodes 108 may be communicatively coupled to a first network, while second nodes 110 may be communicatively coupled to a second network that is different from the first network.

Network 102 may be a single data network or may include any number of communicatively coupled networks. Particularly, according to some embodiments, network(s) 102 may include different types of networks, such as local area network(s) (LANs), wide area network(s) (WANs), metropolitan area network(s), wireless network(s), virtual private network(s) (VPNs), Ethernet network(s), token ring network(s), public switched telephone network(s) (PSTNs), general switched telephone network(s) (GSTNs), switched circuit network(s) (SCNs), integrated services digital network(s) (ISDNs), and/or proprietary network(s).

Additionally, according to some embodiments, network(s) 102 also may employ any suitable networking protocol including transmission control protocol/internet protocol (TCP/IP), hypertext transfer protocol (HTTP), file transfer protocol (FTP), T.120, Q.931, stream control transmission protocol (SCTP), multi-protocol label switching (MPLS), point-to-point protocol (PPP), real-time protocol (RTP), real-time control protocol (RTCP), real-time streaming protocol (RTSP), and/or user datagram protocol (UDP). Any suitable combination of network types and network protocols may be used, particularly when there are two or more networks, such as the first and second networks, connected to the event manager system.

Additionally, according to some embodiments, network(s) 102 also may employ any suitable call signaling protocols or connection management protocols, such as Session Initiation Protocol (SIP) and H.323. The network type, network protocols, and the connection management protocols may collectively be referred to as “network characteristics.” Any suitable combination of network characteristics may be used, particularly when there are two or more networks, such as first and second networks, connected to the event manager system. The second network may be referred as having “different network characteristics” from the first network if those networks differ in network type, network protocol, and/or connection management protocol.

Use of the various network protocols and/or connection management protocols may be harmonized by event focus 24, which may translate data to and/or from a protocol preferred by event manager 26, as further described below. Alternatively, or additionally, hoster 22 may convert network protocol(s) to harmonize the various network protocols used by the networks. For example, hoster 22 may convert network protocols such that simulated nodes generated by the hoster use network protocols that are compatible with other first and/or second nodes.

As discussed, nodes 100 may include physical nodes 111 and simulated nodes 27. One or more of nodes 100 that are participating in an event may be referenced during the event through a unique identifier. That identifier may be intrinsic to the system, connection dependent such as IP address or telephone number, assigned by the event manager based on event properties, and/or decided by another policy asserted by the system.

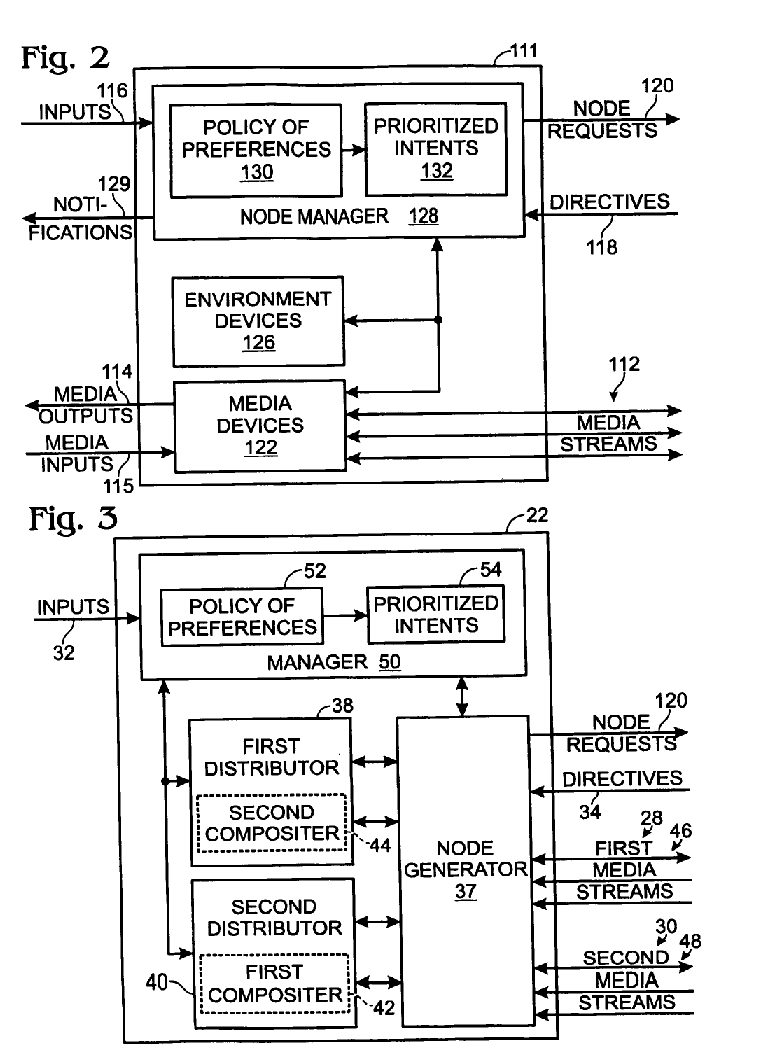

FIG. 2 shows components of physical node 111, as well as connections of the node to event management system 20, according to some embodiments. As generally illustrated, physical node 111 is a system that may participate in a collaborative event by receiving, presenting, and/or transmitting media data. Accordingly, physical node 111 may be configured to receive and/or transmit media information or media streams 112, to generate local media outputs 114, to receive attendee inputs 116 and/or system directives 118, and/or to transmit node requests 120. The form of physical node 111 may vary greatly in capability, and may include telephone(s), personal digital assistant(s) (PDAs), laptop(s), computer system(s), video conferencing studio(s), and/or any other system capable of connecting to and/or transmitting data over a network.

As shown, physical node 111 may include any suitable number of media devices 122, which may include any suitable structure configured to receive media streams 112, display and/or present the received media streams (such as media output 114), generate or form media streams 112 (such as from media inputs 115), and/or transmit the generated media streams. In some embodiments, media streams 112 may be received from and/or transmitted to other nodes 100 and/or hoster 22. According to some embodiments, physical node 111 may be in the form of a telephone, which may include a speaker and a microphone as media devices 122. Alternatively, or additionally, the media devices may include microphone(s), camera(s), video screen(s), keyboard(s), scanner(s), and/or other input and/or output device(s).

Media device 122 may comprise any hardware and/or software element(s) capable of interfacing with one or more other nodes 100, the hoster, and/or one or more networks 102. One or more of the media devices may be configured to receive media streams 112, and/or to reproduce and/or present the received media streams in a manner discernable to an attendee. Physical node 111 also may include one or more environment devices 126, which may include any suitable structure configured to adjust the environment of that node and/or support one or more functions of one or more other nodes 100 and/or the hoster. The environment devices may include participation capabilities not directly related to media stream connections. For example, environment devices 126 may change zoom setting(s) of one or more cameras, and/or may adjust lighting.

According to some embodiments, media devices 122 may be communicatively coupled to various possible media streams 112. Any number of media streams 112 may be connected to the media devices, according to the event topology and/or node capabilities. The coupled media streams may be heterogeneous and/or may include media of different types. According to some embodiments, the physical node may simultaneously transmit and/or receive media streams 112 comprising audio data only, video and audio, video and audio from a specified camera position, and/or collaboration data from a computer display to different nodes participating in an event.

Media streams 112 connected across two or more networks 102 may exchange data in a variety of formats. The media streams or media information transmitted and/or received may conform to coding and decoding standards including G.711, H.261, H.263, H.264, G.723, common intermediate format (CIF), and/or proprietary standard(s). Additionally, or alternatively, any suitable computer-readable file format may be transmitted to facilitate the exchange of text, sound, video, data, and/or other media types.

As shown in FIG. 2, physical node 111 also may include a node manager 128, which may include any suitable structure adapted to process attendee input(s) 116 and/or other system directive(s) 118, and to configure one or more of the various media devices 122 based, at least in part, on the received directives 118. In some embodiments, the node manager may interpret directives received from the event focus and generate, for example, device-specific directives for its media and/or environment devices based, at least in part, on the received directives. Configuration of the media devices and/or the level of participation may be varied by the capabilities of the node and/or variations in the desires of attendees, such as provided by the attendee input(s). The node manager also may send notifications 129 that may inform users and/or attendees of the configuration of the media devices, other nodes in the event and/or attempting to connect to the event, etc.

The various modes of participation may be termed intents, and may include n-way audio and video exchange, audio exchange only, audio and high-resolution video, audio and low-resolution video, dynamically selected video display, audio and graphic display of collaboration data, audio and video receipt without transmission, and/or any other combination of media input and/or output. The intent of a physical node may be further defined to include actual and/or desirable relationships present among media devices 122, media streams 112, and other nodes 100, which may be in addition to the specific combination of features and/or media devices 122 already activated to receive and/or transmit the media streams. Additionally, or alternatively, the intent of a physical node may include aspects that influence environment considerations. For example, the number of seats to show in an event, which may, for example, impact zoom setting(s) of one or more cameras.

As shown in FIG. 2, the node manager may include a pre-configured policy of preferences 130 within the node manager that may create a set of prioritized intents 132 from the possible modes of participation for the physical node during a particular event. The prioritized intents may change from event to event and/or during an event. For example, the prioritized intents may change when a physical node attempts to join an event, leave an event, participate in a different manner, and/or when directed by the attendee.

As physical node 111 modifies its prioritized intents 132, node request 120 may be sent to the event manager system. In some embodiments, node requests 120 may be sent to the event focus and/or the hoster. In one example, the node request may comprise one or more acts of connection, such as dialing a telephone number. In another example, the node request may include the prioritized intents and information about the capabilities of the physical node transmitting the node request. The node type, which may indicate capabilities of the physical node and/or relationships among the media devices, is an example of information about capabilities, and may be summarized by a token. For example, the token may be “B2B6,” which may imply “three displays, three cameras, three microphones, one speaker system.” Additionally, or alternatively, the node type and/or associated token may indicate relationships among media devices 122, such as the positioning of three displays to the left, right, and center relative to an attendee.

A physical node may not automatically send the same information of its capabilities and relationships in every situation. Physical node 111 may repeatedly select and/or alter the description of capabilities and/or relationships to disclose. For example, if physical node 111 includes three displays but the center display may be broken or in use, that node may transmit information representing only two displays, one to the right and one to the left of an attendee. Thus, the information about capabilities and relationships of the physical node that event manager may receive may be indicated through the node type and/or prioritized intents 132. The node request may additionally, or alternatively, comprise a form of identification. Although particular components are shown for physical node 111, one or more of the physical nodes may alternatively, or additionally, include one or more other components.

FIG. 3 shows components of hoster 22, as well as connections of the hoster to nodes 100, such as first nodes 108 and/or second nodes 110, and to event focus 24 and/or event manager 26. As generally illustrated, hoster 22 is a system that may be communicatively coupled to network(s) 102, such as first and/or second networks, and may be configured to participate in a collaborative event by generating one or more simulated nodes 27, and transmitting and/or receiving media stream(s) and/or data as a participant in the collaborative event and/or from the simulated nodes. Accordingly, hoster 22 may receive, present, and/or transmit media information or media streams.

For example, hoster 22 may be configured to receive first media streams 28 transmitted from at least one first node 108 to at least one of simulated node 27, and/or to transmit the first media streams to at least one second node 110. Hoster 22 may additionally, or alternatively, be configured to receive second media streams 30 from at least one second node, and/or to transmit the second media streams from at least one of simulated node 27 to the at least one first node. In some embodiments, first nodes 108 and/or simulated nodes 27 may be communicatively coupled to a first network, while second nodes 110 may be communicatively coupled to a second network that is different from the first network.

Additionally, or alternatively, hoster 22 may be configured to receive inputs 32 and/or system directives 34, and/or to transmit node requests 36. The physical form of hoster 22 may include hardware and/or software/firmware and may include various components, such as coding/decoding mechanisms, media and/or control connector(s), and/or any other system capable of connecting to and/or transmitting data over one or more networks.

For example, hoster 22 may include a synthetic bridge that may remove all network protocol information from second nodes 110 before transferring data over to first nodes 108, event focus 24, and/or event manager 26. Examples of synthetic bridges are described in PCT Patent Application No. PCT/US2007/074851 entitled “Synthetic Bridging,” and filed Jul. 31, 2007. The complete disclosure of that application is herein incorporated by reference for all purposes.

Additionally, or alternatively, hoster 22 may include one or more coding/decoding mechanisms and one or more management systems supported on one or more compute platforms. Alternatively, or additionally, hoster 22 may include at least some components of telephone(s), personal digital assistant(s), laptop(s), computer system(s), video conferencing studio(s), and/or other system(s) capable of connecting to and transmitting data over at least one network.

Hoster 22 may be referenced during an event through a unique identifier, while one or more simulated nodes generated by the hoster may have their own unique identifiers. Those identifiers may be intrinsic to the system, connection dependent such as IP address or telephone number, assigned by the event manager based on event properties, and/or decided by another policy asserted by the system.

As shown, hoster 22 may include a node generator 37, a first distributor 38, and a second distributor 40. Node generator 37 may include any suitable structure configured to generate one or more simulated nodes 27. Simulated nodes 27 may include one or more components and/or one or more functions of physical nodes 111 described above, as provided by hoster 22. For example, from the perspective of the first physical nodes, the event focus, and the event manager, simulated nodes 27 may include a manager and media devices similar to the first physical nodes. Any suitable number of simulated nodes 27 may be generated by the hoster. In some embodiments, at least one first simulated node is generated by the node generator for each second node communicatively coupled to the hoster.

First distributor 38 may include any suitable structure configured to receive second media streams 30 from at least a second node, and/or to transmit the received second media streams from at least one simulated node 27 to at least one first node 108. Second distributor 40 may include any suitable structure configured to receive first media streams 28 transmitted from at least a first node to at least one simulated node 27, and/or to transmit the received first media streams to at least one second node 110.

In some embodiments, first distributor 38 may include a second compositor 44, which may include any suitable structure configured to form second composite media streams 48 from the received second media streams.

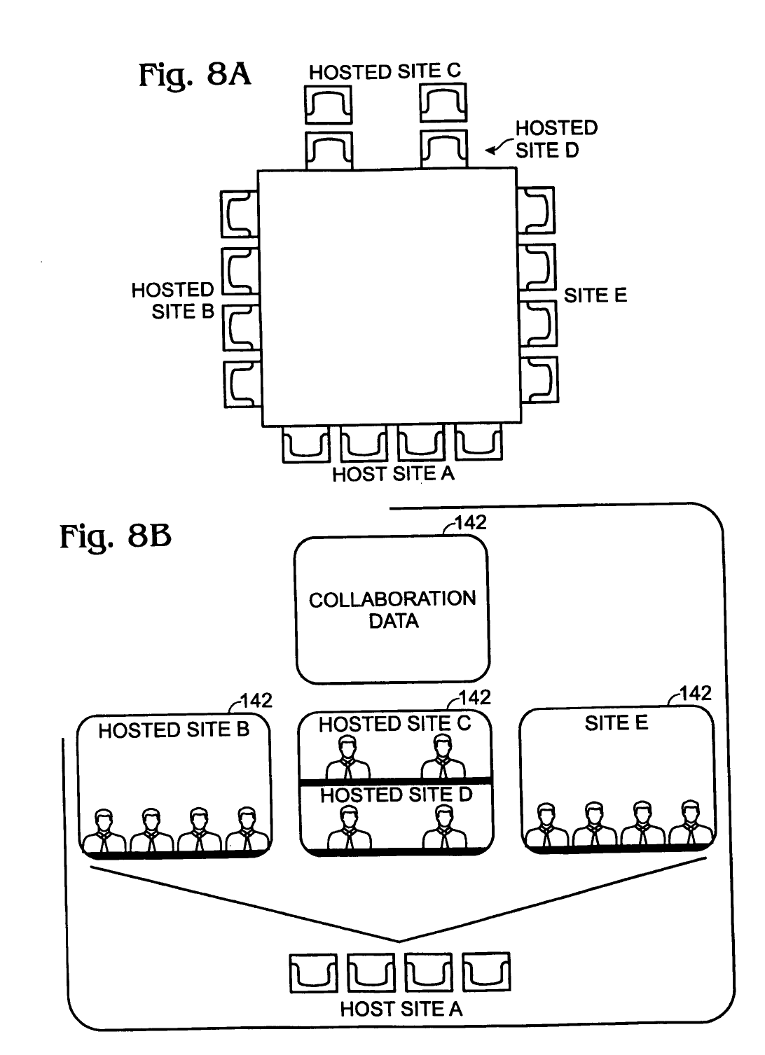

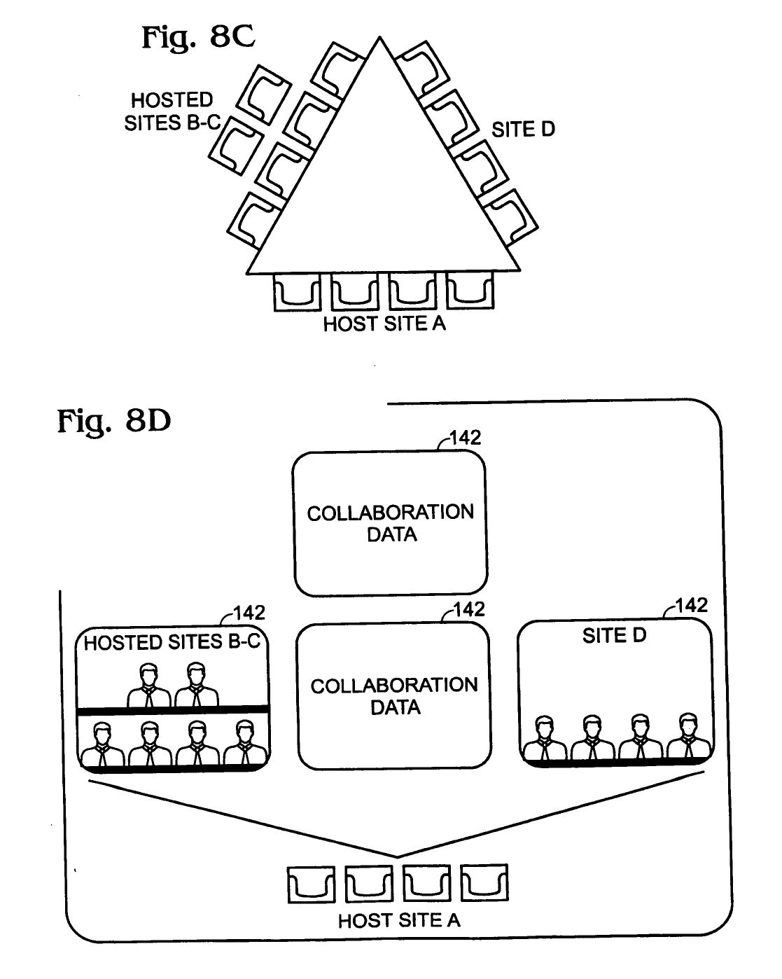

In some embodiments, second distributor 40 may include a first compositor 42, which may include any suitable structure configured to form first composite media streams 46 from the received first media streams. The first and second compositors may include any suitable structure configured to combine and/or arrange outputs from multiple media streams into a single output. For example, the first and/or second compositors may combine and/or arrange video images from multiple media streams into a single image. Examples of presentation of first and second composite media streams are provided in FIGS. 8B and 8D, which are discussed below.

As shown in FIG. 3, hoster 22 also may include a manager 50, which may include any suitable structure adapted to receive and/or process input(s) 32 and/or other system directive(s) 34, and to configure the node generator, first distributor, and/or the second distributor based, at least in part, on the received directives. Inputs may include signals from one or more nodes 100 and/or one or more user inputs. The intent of hoster 22 may include actual and/or desirable relationships present among first media streams 28, second media streams 30, first nodes 108, and/or second nodes 110, which may be in addition to the specific combination of features already activated to receive and/or transmit the media streams.

As shown in FIG. 3, manager 50 may include a pre-configured policy of preferences 52 within the manager that may create a list of prioritized intents 54 from the possible modes of participation for the hoster during a particular event. The prioritized intents may change from event to event and/or during an event. For example, the prioritized intents may change when a node, such as a second node, attempts to join an event, leave an event, and/or participate in a different manner through the hoster. Manager 50 may receive signals from at least one second node. Additionally, or alternatively, manager 50 may transmit node requests from the one or more simulated nodes, and/or hoster requests from the hoster, to the event focus and/or the event manager based, at least in part, on the received signals.

Additionally, manager 50 may replicate its event participation logic within the one or more simulated nodes, such as providing one or more of the simulated nodes with its own virtual manager, based, at least in part, on the received signals. That replication may allow other nodes 100, such as first nodes 108, to interact with those simulated nodes without recognizing the dependence of the simulated nodes on the hoster. Alternatively, or additionally, manager 50 may represent the hoster multiple times under different guises, such as the one or more simulated nodes and/or the hoster itself, based, at least in part, on the received signals. The manager may allocate one or more of its resources or components, and/or one or more portions of those resources, for the one or more simulated nodes.

As hoster 22 modifies its prioritized intents 54, node requests 36 may be sent and/or transmitted from one or more of the simulated nodes to event focus 24 and/or event manager 26. In one example, the node request may comprise one or more acts of connection, such as connecting one or more simulated nodes to an event that may include one or more first nodes 108 participating. In another example, the node request may include the list of prioritized intents and information about the capabilities and/or preferred modes of participation of the simulated node.

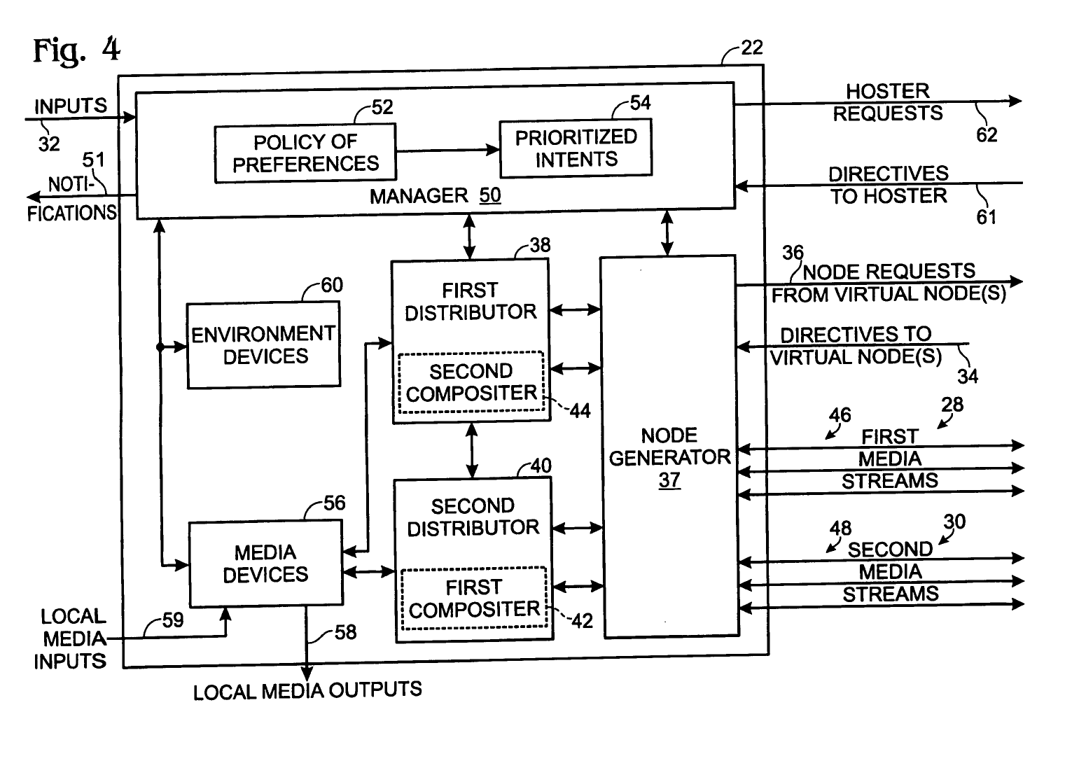

In some embodiments, hoster 22 may include any suitable number of media devices 56, as shown in FIG. 4 and generally indicated at 22′. Media devices 56 may include any suitable structure configured to receive media streams from the first distributor and/or the second distributor, display and/or present the received media streams (such as local media output 58), generate or form media streams (such as from local media inputs 59), and/or transmit the generated media streams to first distributor and/or the second distributor for further distribution, such as from at least one simulated node to at least one first node and/or to at least one second node. Media devices 56 may include telephone(s), microphone(s), camera(s), video screen(s), keyboard(s), scanner(s), and/or other input and/or output device(s).

Media devices 56 may comprise any hardware and/or software element(s) capable of interfacing with the first distributor, the second distributor, one or more other nodes 100, and/or one or more networks 102. One or more of the media devices may be configured to receive media streams from the first distributor and/or the second distributor, and/or reproduce and/or present the received media streams in a manner discernable to an attendee. Hoster 22′ may additionally, or alternatively, include one or more environment devices 60, which may include any suitable structure configured to adjust the environment of the hoster and/or support one or more functions of one or more other nodes 100.

According to some embodiments, media devices 56 may be communicatively coupled to various possible media streams. Any number of media streams from the first distributor and/or the second distributor may be connected to the media devices, according to the event topology and capabilities of the hoster. The coupled media streams may be heterogeneous and/or may include media of different types. In some embodiments, such as where the hoster includes one or more media devices 56 and/or one or more environment devices, manager 50 of the hoster may additionally, or alternatively, be adapted to receive and/or process hoster directives 61 and configure the first distributor, the second distributor, the node generator, the media device(s) and/or the environment device(s) based, at least in part, on the received directives. Additionally, or alternatively, manager 50 may send hoster requests 62 to the event focus and/or the event manager based, at least in part, on the prioritized intents. Alternatively, or additionally, the manager may generate notifications 51 to provide information to users and/or attendees of the configuration of media devices, node(s) participating and/or requesting participation in the event, etc.

Although a single hoster is shown, event manager system 20 may include two or more hosters, which may distribute media streams among nodes communicatively coupled to one or more networks. For example, a first hoster may be configured to represent one or more nodes communicatively coupled to a second network as one or more simulated nodes communicatively coupled to a first network, while a second hoster may be configured to represent one or more nodes communicatively coupled to a third network as one or more simulated nodes communicatively coupled to the first network.

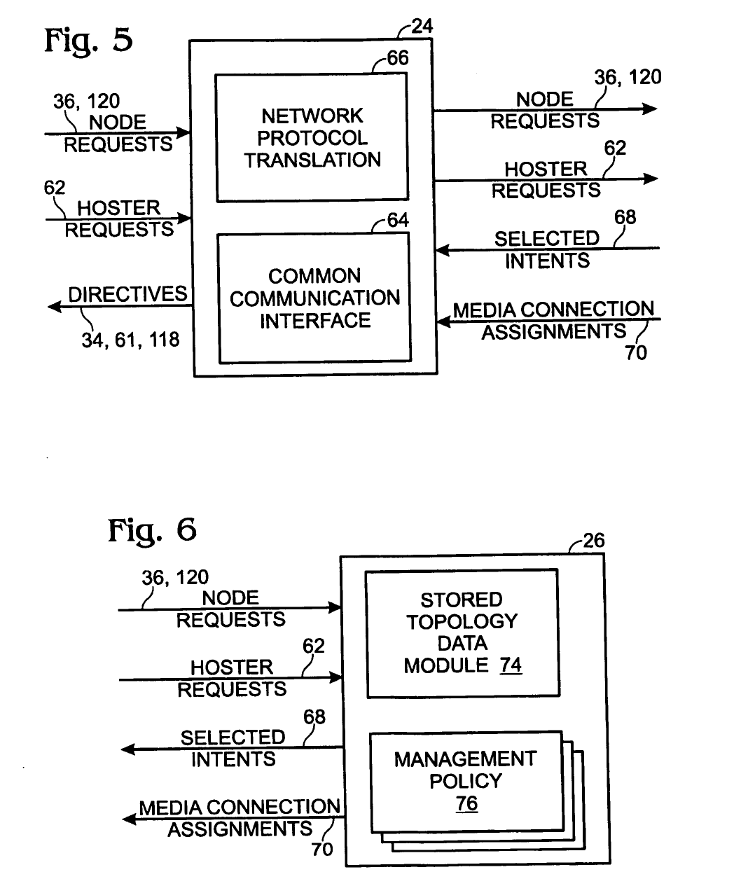

FIG. 5 shows the elements and functions of event focus 24, according to some embodiments. The event focus may be configured to perform intermediate processing before relaying requests, such as node requests 36, 120 and/or hoster requests 62, to event manager 26. Specifically, the event focus may include a software module capable of remote communication with the manager of one or more of nodes 100, the manager of one or more of simulated nodes 27, and/or hoster 22.

Event focus 24 may include a common communication interface 64 and a network protocol translation 66, according to some embodiments. The common communication interface and/or the network protocol translation may allow the event focus to receive node requests 36, node requests 120, and/or hoster requests 62 from one or more nodes 100 and/or hoster 22, translate those requests, forward the requests to event manager 26 and receive selected intents 68 and/or media connection assignments 70 from the event manager. In some embodiments, the event focus may receive requests from the first nodes and/or the hoster.

The selected intents and media connection assignments may then be translated to directives by the event focus for transmission to selected nodes, selected simulated nodes, and/or the hoster. The use of event focus 24 to forward and process requests to the event manager may eliminate a need for individual nodes 100 to guarantee compatibility with potentially unforeseen network topologies and/or protocols.

In some embodiments, the simulated nodes may be made compatible with the network topologies and/or protocols of the first physical nodes by the hoster. Alternatively, or additionally, the nodes may participate in an event through various types of networks, which may each have differing capabilities and/or protocols. The event focus may provide at least some of the nodes with a common point of contact with the event. According to some embodiments, node requests 36, node requests 120, and/or hoster requests 62 transmitted to event focus 24 may be interpreted and converted to a format and/or protocol meaningful to event manager 26.

After the event manager determines the new event topology and media stream connections, the event manager may transmit the data to the event focus for distribution to the nodes and/or the hoster. Event focus 24 may then communicate individualized directives to one or more of nodes 100 and/or the hoster that are affected by the directives, indicating a change in the participation of the various nodes and/or the hoster. In some embodiments, the event focus may send directives to first nodes 108 and/or hoster 22.

According to some embodiments, directives may include the selected intent and/or new media connection assignments among the node and/or the hoster receiving the directive and any number of participating nodes, simulated nodes, and/or the hoster. The event focus may be configured to communicate the various directives to nodes 100 through the preferred or actual network protocol for each participating node and/or the hoster.

Node 100, such as first node 108 and/or second node 110, may include a telephone that may submit a request 120 to join an event in the form of dialing a number. Those requests may implicitly indicate that the attendee's system supports the exchange of audio data and that the attendee desires to participate in the event in audio mode. Other requests may be more explicit. Node 100 also may send a request, which may be interpreted and/or translated to an appropriate form by event focus 24 before the request may be communicated to event manager 26. In some embodiments, requests from second nodes 110 may be received by the manager of the hoster. That manager may then send out node requests 36 from one or more simulated nodes 27 and/or hoster requests 62 to the event focus based, at least in part, on the requests from the second nodes.

When the event manager generates media stream assignments, the event focus may form directives useful to one or more of nodes 100 and/or the hoster, which, in the case of the telephone node, may comprise an established connection to a stream of composite audio data for the conference. The event focus may not determine which connections to assign but may provide the event manager one or more channels through which to communicate node configuration and/or hoster configuration data, even if the data may be destined for networks of differing protocols and/or capabilities.

A single event focus 24 may communicate using multiple networks and/or protocols, and thus acts as a gateway among nodes 100, hoster 22, and/or event manager 26. In addition, multiple nodes 100 using the same protocol may communicate with event manager 26 through a single event focus 24. The event focus also may allow the event manager to communicate with nodes 100 from many manufacturers, which may connect through Session Initiation Protocol (SIP) or other standards.

Communication between a node 100 and event manager 26 may be routed through at least one event focus 24, even if the node and the event manager use the same network and/or protocol. In some embodiments, event management system 20 may include multiple event focuses where each event focus may be associated with one or more network protocols and/or connection management protocols used by particular types of nodes. Alternatively, or additionally, one or more of the multiple event focuses may be capable of multiple network protocols and/or connection management protocols used by particular types of nodes.

According to another illustrative example, one node 100 coupled to the illustrative event manager system may participate in an event through a local area network, another node may participate through the Internet, and a third node may participate through an encrypted virtual private network (VPN). The nodes may be physical nodes and/or simulated nodes that are generated by the hoster. As each node 100 joined the event, left the event, or requested to change intent, the corresponding node request may be translated by the associated event focus into the form preferred by the event manager. The module for network protocol translation 66 may employ encryption, decryption, authentication, and/or other capabilities to facilitate communication among the nodes and the event manager. In some embodiments, hoster 22 may incorporate at least some of the components and/or functions of the event focus. Although a single event focus 24 is shown, the event manager system may include two or more event focuses, each of which may be connected to different sets of nodes communicatively coupled to one or more networks.

FIG. 6 shows the components, inputs, and outputs of event manager 26, according to some embodiments. The event manager may communicate with the event focus directly. However, according to one alternative illustrative example, the event manager may be communicatively coupled to the event focus via a communication network. Alternatively, such as in embodiments where hoster 22 includes at least some components and/or functions of the event focus, the event manager may communicate directly with the hoster and/or the nodes.

Regardless of the communication means between the event focus and the event manager, the event manager may include a data storage module or stored topology data module 74 and a plurality of management policies 76. According to some embodiments, the stored topology data module associated with the event manager may describe the state and/or topology of an event, as perceived by the event manager. That data may, according to some embodiments, include the identity of nodes 100 and/or hoster 22 participating in an event, the virtual relationships among the nodes and/or the hoster, the intent or manner in which the nodes and/or the hoster are participating, and the capabilities of the nodes and/or the hoster.

Event manager 26 also may maintain a record of prioritized intents for one or more of nodes 100 and/or hoster 22. As mentioned previously, an intent may include information about relationships among multiple nodes 100, node media devices 122, and/or the hoster, whether present or desired. Additionally, an intent may specify a narrow subset of capabilities of node 100 and/or hoster 22 that are to be utilized during a given event in a certain manner. For example, a first node may include three displays capable of displaying multiple resolutions. An intent for the first node may include a specified resolution for media received from a certain second node, as well as the relationship that the media streams from the second node should be displayed on the left-most display. Additionally, event manager 26 may optimize an event topology based on the intents and/or combinations of intents received.

According to some embodiments, event manager 26 may be configured to receive node requests 120, simulated node requests 36, and/or hoster requests 62 from at least one event focus. The node requests and/or the hoster requests may be identical to the requests originally generated by the nodes and/or the hoster, or may be modified by the event focus to conform to a certain specification, interface, or protocol associated with the event manager.

According to some embodiments, the event manager may make use of stored topology data 74 to create new media connection assignments 70 when node 100 or hoster 22 requests to join an event, leave an event, or change its intent. Prioritized intent information may allow the event manager to assign media streams most closely matching at least some of the attendee's preferences. Additionally, virtual relationship data may allow the event manager to minimize disruption to the event as the topology changes, and node and/or hoster capability data may prevent the event manager from assigning media streams not supported by an identified node or the hoster.

When a change in topology is requested or required, the event manager may select the highest priority intent acceptable to the system for one or more of nodes 100 from the prioritized intents. The selected intent may represent the mode of participation implemented for that node at that time for the specified event. Changes in the event or in other systems participating in the event may cause the event manager to select a different intent as conditions change. Selected intents may be conditioned on any number of factors including network bandwidth or traffic, the number of other nodes participating in an event, the prioritized intents of other participating nodes and/or other nodes scheduled to participate, a policy defined for the current event, a pre-configured management policy, and/or other system parameters.

According to some embodiments, management policies 76 associated with the event manager may be pre-configured policies, which, according to one example, may specify which nodes and/or attendees are permitted to join an event. The management policies may additionally, or alternatively, apply conditions and/or limitations for an event including a maximum duration, a maximum number of connected nodes, a maximum available bandwidth, a minimum-security authentication, and/or minimum encryption strength. Additionally, or alternatively, management policies may determine optimal event topology based, at least in part, on node intents.

The event manager may be configured to transmit a description of the updated event topology to event focus 24. That description may include selected intents 68 for one or more of nodes 100 and/or the hoster as well as updated media connection assignments 70 for those nodes and/or the hoster. The formation of media connection assignments by the event manager may provide for the optimal formation and maintenance of virtual relationships among the nodes and/or the hoster.

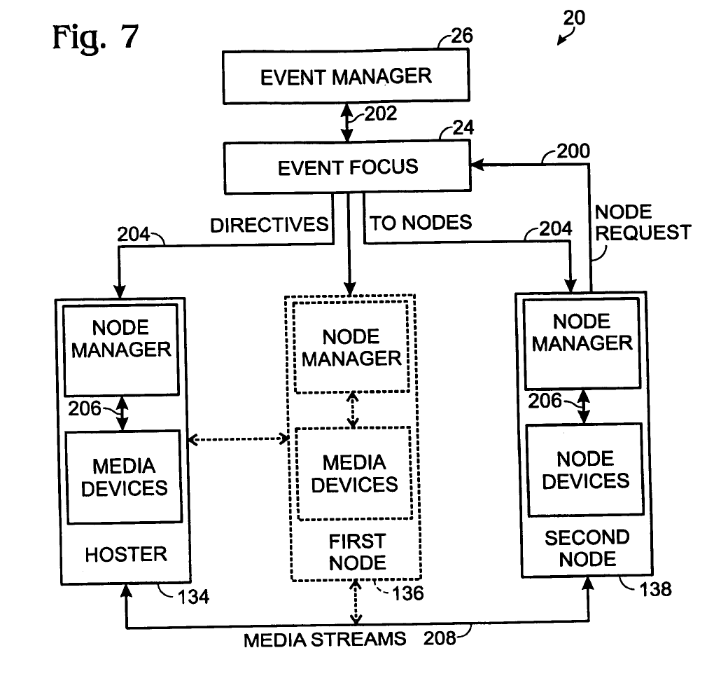

Topology and intent information also may be used to modify the environment of one or more of nodes 100 and/or hoster 22, including the media devices not directly related to the transmission, receipt, input, and/or output of media. Central management by the event manager may apply consistent management policies for requests and topology changes in an event. Additionally, the event manager may further eliminate potentially conflicting configurations of media devices and media streams. Details of the illustrative operation of the event manager system will be described below, with reference to FIGS. 7 through 12 below.

FIG. 7 shows a sequence of connections utilized as a second node 138 joins an event in progress, according to some embodiments. The event in progress may include a hoster 134, and a first node 136 virtually generated by the host. According to the illustrative example illustrated in FIG. 7, the second node may send an initial request to the event focus requesting to join the event, illustrated by arrow 200. Request 200 may contain information that includes the node type, and/or capabilities of the second node, as well as prioritized intents or preferred modes of participation of the second node.

When the initial request is received by the event focus, the event focus may then forward the request to the event manager, and, in turn, may receive those aspects of the updated event topology from the event manager which are necessary to be transmitted to hoster 134 and first node 136, including new media connection assignments and/or selected intents. The two-way communication between the event manager and the event focus is illustrated by the communication arrow 202.

After receiving the updated event topology from the event manager, including new media connection assignments and/or selected intents, the event focus may translate the new media connection assignments and/or selected intents into directives. Once translated, the directives may be transmitted to node(s) that are experiencing a change in configuration (also may be referred to collectively as “affected nodes”) and/or to the hoster, if it is experiencing a change in configuration, as illustrated by transmission arrows 204.

As the affected node(s) and/or the hoster receive the transmitted directives, manager(s) may interpret and may apply the directives received and may send appropriate configuration data and commands to its media device(s) and/or other component(s) to support the new topology. The mentioned communication among the node manager and the media device(s) are illustrated as communication arrows 206.

When appropriately configured to reflect the understood topology, media streams may be connected among the various nodes and/or the hoster as previously assigned by the event manager. The transmission of the various media streams is illustrated by communication arrow 208. The illustrative configuration illustrated in FIG. 7 may provide for dynamic adjustments of system topology while managing intents, capabilities, and/or configurations of the node(s) and/or the hoster.

FIGS. 8A through 8B illustrate typical virtual relationships present in topologies containing one of a first node, a hoster with media devices and attendees, and three of second nodes that are virtually represented as two nodes by the hoster. Similarly, FIGS. 8C through 8D illustrate optimal virtual relationships present in topologies containing one of a first node, a hoster with media devices and attendees, and two of second nodes that are virtually represented as a single node by the hoster, according to various examples.

While FIGS. 8A through 8D illustrate topologies containing either three or four nodes, the present illustrative system is in no way limited to the topologies depicted. Rather, varying numbers of nodes allow for many complex topologies. For a given event, the optimal virtual relationships may vary, even for topologies containing the same number of nodes. For example, node capabilities may vary and may contain any suitable combination of additional displays, cameras (with any suitable camera angle(s)), and/or other media devices to allow additional relationships.

As illustrated in FIGS. 8A through 8D, each of sites A-E depicted represents a node with at least one attendee present. Additionally, sites A and E illustrated in FIGS. 8A-8B, and sites A and D illustrated in FIGS. 8C-8D, have three cameras and four displays 142. In contrast, sites B-D illustrated in FIGS. 8A-8B, and sites B-C illustrated in FIGS. 8C-8D have a single camera and a single display and are represented as simulated nodes by host site A. However, nodes participating in the present systems and methods may have any suitable number of cameras and/or displays.

According to some embodiments, the virtual relationships established among the various nodes by the event manager system may simulate spatial relationships among attendees and promote meaningful interaction. Particularly, according to some embodiments, the perceived topology and issued directives may correspond to certain virtual relationships being envisioned as seats around an imaginary table, where video and/or audio are perceived to come from the left, right, or directly in front of the attendee. According to some embodiments, the virtual relationships may be maintained throughout an event, giving an event a sense of realism and eliminating distractions.

According to some embodiments, the consideration of relationships among the nodes and their corresponding video streams may allow an attendee to speak with remote attendees as if they were looking through a virtual window. One type of virtual relationship may include, for example, the association of a video input stream from an identified node with a corresponding display, camera, and video output stream to allow natural eye contact among attendees at the two nodes. If video from a first node is displayed on the left-most display of a second node, the left-most camera of the second node may be configured to capture the video stream sent back to the first node. Consequently, when an attendee turns to view the left display, his expressions and comments may be transmitted as if he were speaking directly to the attendee displayed on his screen. The connection of video streams to appropriate displays may maintain natural eye contact and may facilitate natural communication among attendees. Additionally, this illustrative configuration may allow the participants to know when other participants are distracted or are shifting their attention from one participant to another.

In conjunction with the video arrangement described above, audio streams also may be linked among attendees based on a virtual relationship among the nodes. Specifically, according to some embodiments, audio recorded from a specific node may be reproduced at the recipient node with the same orientation as the display showing the attendee transmitting the audio stream. Each attendee's voice received may then correspond spatially with the video image of that attendee, enhancing the perceived relationship among the attendees.

According to some embodiments, the event manager may store the topology data containing a record of virtual relationships present in an event and generates the above-mentioned perceived relationships. As the event manager receives node requests and/or hoster requests, at least some changes in topology may take into consideration the best configuration to maintain those virtual relationships and form new ones as necessary. These considerations allow smooth transitions among topologies with varied numbers of participating nodes.

Additionally, media streams from second nodes 110 may be composited by the hoster before being transmitted from one or more simulated nodes 27 to first nodes 108. Additionally, or alternatively, media streams transmitted from first nodes 108 to the one or more simulated nodes may be composited by the hoster before being transmitted to second nodes 110. Examples of second media streams composited by the hoster are shown in the display for hosted sites C-D in FIG. 8B and hosted sites B-C in FIG. 8D. Similar compositing may be performed by the hoster for the first media streams before those streams are transmitted to the second nodes. Although the hoster is shown to be participating in the collaborative events shown in FIGS. 8A-8D in addition to the simulated nodes or hosted sites it represents, the hoster may alternatively participate only through its simulated nodes or hosted sites.

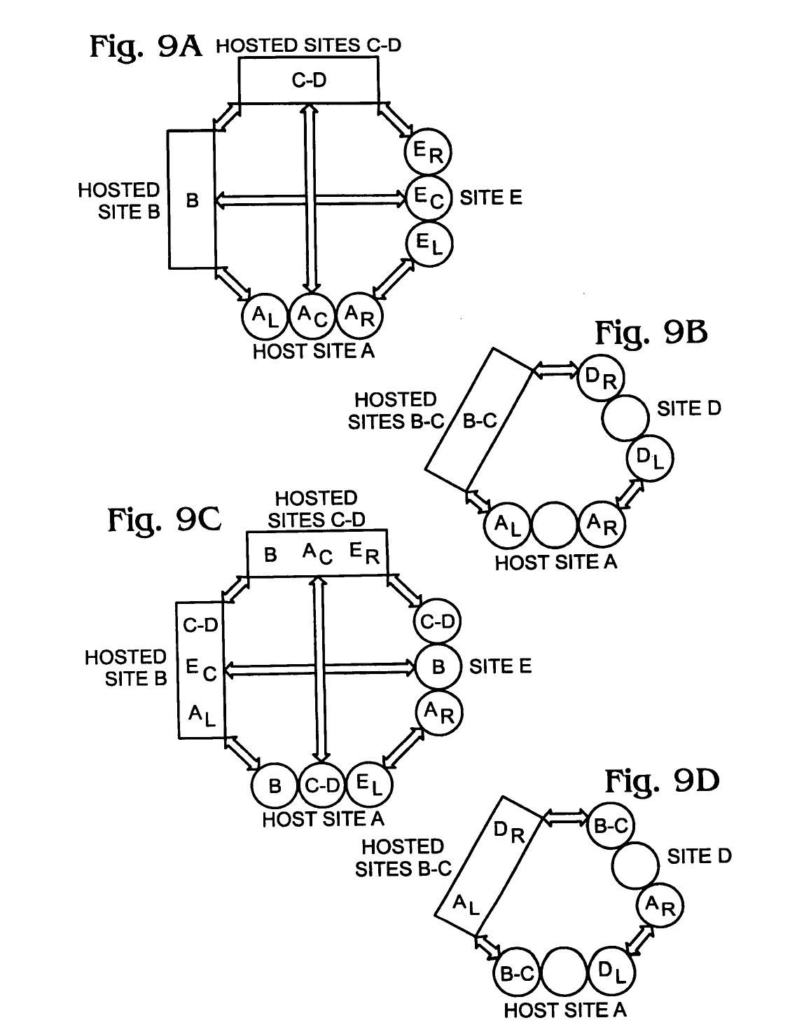

While FIGS. 8A through 8D illustrate virtual relationships in illustrative three and four node configurations, FIGS. 9A through 9D illustrate optimal media connections present in topologies containing three and four nodes where the hoster and one or more of the nodes may select among three available camera views, according to some embodiments. As mentioned previously, the three and four node topologies are merely examples. Any number of nodes may be managed according to the teachings of the present illustrative systems and methods.

According to some embodiments illustrated in FIGS. 9A through 9D, nodes may be allowed to form virtual relationships based on the direction and assignment of streams received and transmitted. As shown, sites labeled “A” and “E” in FIGS. 9A and 9C, and sites labeled “A” and “D” in FIGS. 9B and 9D represent a node with at least three cameras or available camera angles and at least three displays. The media connections indicated may originate from the site specified and the left, center, or right camera view is indicated by a subscript of “L”, “C”, or “R.” The designation “A_{C},” for example, indicates a media stream originating from the center camera of site or node A.

For example, in the three node topology illustrated in FIG. 9B, the rightmost camera of site A may transmit its stream “A_{R}” to the leftmost display of site D. Additionally, the rightmost display of site A (A_{R}) may receive the leftmost camera view of site D denoted as “D_{L}.” Moreover, as illustrated in FIG. 9D, the orientation of the streams transmitted corresponds to the orientation of the streams received in FIG. 9B, further adding to consistency and a sense of realism. Streams from the second nodes may be received as a composite stream in the appropriate displays in sites A and E in FIGS. 9A and 9C, and sites A and D in FIGS. 9B and 9D. For example, sites C-D are second nodes with its streams received as a composite stream in sites A and E in FIGS. 9A and 9C.

While the examples depicted in FIGS. 9A through 9D involve nodes with at least three cameras and at least three displays and nodes with a single camera and a single display, nodes with any suitable combination of media devices may participate in an event and/or the event topology depicted in those figures. For example, a node having only a telephone may participate in the topologies depicted through audio only. Attendee preferences, bandwidth limitations, policies and restrictions for a given event, node capabilities, and/or other factors may be considered by the event manager in making the appropriate media connection assignments 70.

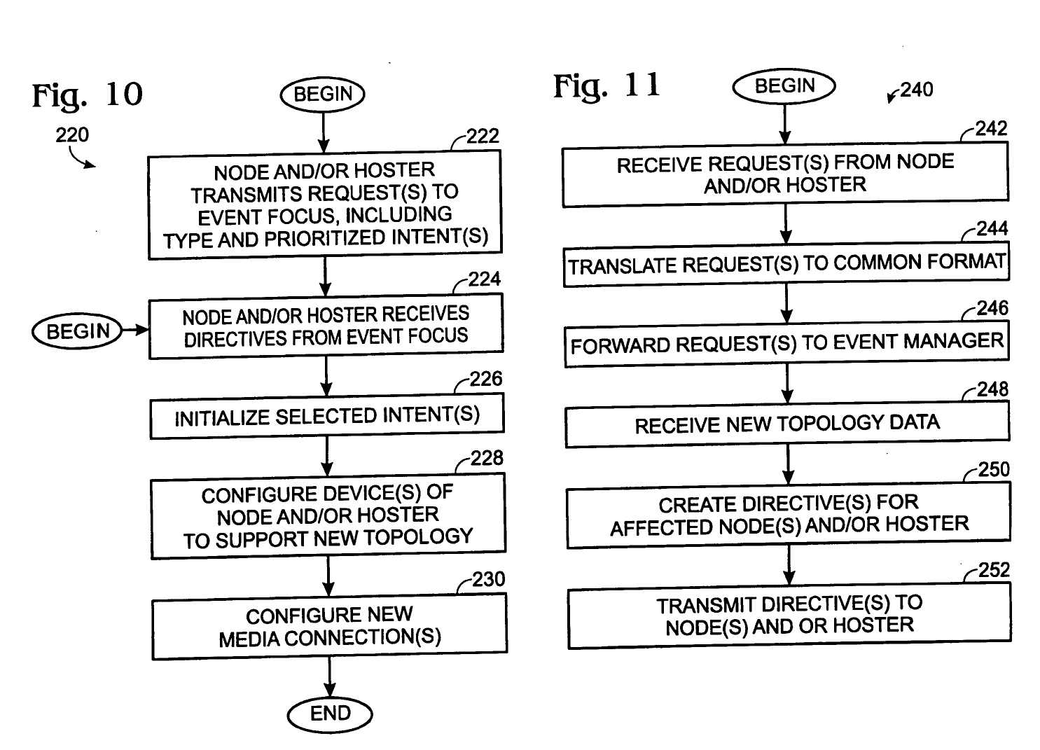

Continuing with the methodologies of the event manager system, FIG. 10 shows an illustrative method of operation of the manager of node 100 or hoster 22, according to some embodiments. While FIG. 10 shows illustrative steps of operation according to one example, other examples may omit, add to, and/or modify any of the steps shown in FIG. 10, as will be understood by one of ordinary skill in the art.

As illustrated in FIG. 10, the illustrative virtual collaboration method may be initiated when a node attempts to join or leave an event, or when a participating node or simulated node changes its desired mode of participation. According to the present illustrative systems and methods, when a node attempts to join or leave an event, or when a participating node changes its desired mode of participation, that node may transmit a request to the event focus at 222. That request may include the prioritized list of intents as well as the node type of the requesting node. The information provided to the event focus may be explicit, but may additionally, or alternatively, be implicitly signaled by the type of request transmitted.

Once the request has been processed, the node that initiated the request may receive directives from the event focus instructing which media connections have been assigned and which intent has been selected at 224. Directives also may be transmitted to one or more of the nodes and/or the hoster that exchange media information with the requesting node in order to establish connections in the new topology. Consequently, as illustrated in FIG. 10, one or more of the nodes and/or the hoster also may begin the process with the transmission of directives from the event focus at 224, even without having initiated a request.

After receiving a directive, the node manager associated with one or more of the nodes may initialize the selected intent corresponding to the received directive at 226. Specifically, according to some embodiments, the node manager may be configured to calculate a preferred configuration of one or more of its associated media devices to comply with the directive received. Additionally, the node manager associated with the receiving node also may change settings and/or execute initialization software to initialize functionality. According to some embodiments, any number of factors may be considered in selecting the preferred configuration for one or more of the media devices in response to a received directive. Particularly, allocation of the media devices and previously received directives may influence the preferred configuration calculated by the node manager.

Once the node has been initialized to the selected intent, the node manager may configure the media device(s) to allow them to support the assigned media connections and topology at 228, and may configure the node's environment devices to optimize participation. For example, the node manager may dim nearby lights to improve the visibility of a display and/or may dim lights over seats that may not be visible in the event. With the media devices and/or the environment devices configured, the node may then be ready to support as many connections as have been assigned, and may support the transmission and receipt of media in the forms specified by the selected intent.

Finally, the media streams connecting one or more nodes and/or the hoster may be established for the new topology at 230. With the media streams established, the exchange of data may begin, and may continue until additional directives change the mode of participation of one or more of the nodes and/or the hoster. In some embodiments of the method of operation, requests from the second nodes may be received by the hoster, and the hoster may generate one or more simulated nodes, and then send node requests from those simulated nodes based, at least in part, on the received requests. In some embodiments, the event focus and the event manager may send directives to the first nodes and the hoster.

Similarly, the illustrative virtual collaboration method may be initiated when the hoster attempts to join or leave an event, or when the hoster is participating in the event and wants to change its desired mode of participation. When the hoster attempts to join or leave an event, or when it changes its desired mode of participation, the hoster may transmit a hoster request to the event focus at 222. That request may include the prioritized list of intents as well as identification information of the hoster. The information provided to the event focus may be explicit, but may additionally, or alternatively, be implicitly signaled by the type of request transmitted.

Once the request has been processed, the hoster may receive directives from the event focus instructing which media connections have been assigned and which intent has been selected at 224. Directives also may be transmitted to one or more nodes that exchange media information with the hoster in order to establish connections in the new topology. Consequently, as illustrated in FIG. 10, one or more of nodes and/or the hoster also may begin the process with the transmission of directives from the event focus at 224, even without having initiated a request.

After receiving a directive, the manager associated with the hoster may initialize the selected intent corresponding to the received directive at 226. Specifically, according to some embodiments, the manager may be configured to calculate a preferred configuration of the hoster media devices to comply with the directive received. Additionally, the manager also may change settings and/or execute initialization software to initialize hoster functionality. According to some embodiments, any number of factors may be considered in selecting the preferred configuration for the one or more of the media devices in response to a received directive. Particularly, allocation of the media devices, and previously received directives may influence the preferred configuration calculated by the manager.

Once the hoster has been initialized to the selected intent, the manager may configure the media device(s) to allow them to support the assigned media connections and topology at 228, and may configure the hoster's environment devices, if any, to optimize participation. With the media devices and/or the environment devices configured, the hoster may then be ready to support as many connections as have been assigned, and may support the transmission and receipt of media in the forms specified by the selected intent.

Finally, the media streams connecting one or more of nodes and/or the hoster may be established for the new topology at 230. With the media streams established, the exchange of data may begin, and may continue until additional directives change the mode of participation of the hoster and/or one or more of the nodes.

FIG. 11 shows an illustrative method of operation 240 of the event focus during an event, according to one example. While FIG. 11 shows illustrative steps according to one example, other examples may omit, add to, and/or modify any of the steps shown in FIG. 11. As illustrated, the operation of the event focus may begin when the event focus first receives a node request from a node and/or a hoster request at 242. As mentioned previously, the node request may be received from any suitable number of nodes.

Once the node request is received, the event focus may translate the request received into a common format preferred by the event manager at 244. The translation to a standard format may include providing a common interface to communicate among multiple network systems and protocols. According to some embodiments, any number of event manager preferred protocols may be used. Once the request is in the correct form, the event focus may forward the request to the event manager at 246.

After the event manager has received and/or processed the node request, updated topology data may be transmitted from the event manager to the event focus. The event focus may receive the updated topology data from the event manager at 248, and may create directives for the affected nodes and/or the hoster based, at least in part, on the updated topology data at 250. The topology data received from the event manager may designate the intents selected for one or more of the nodes as well as the source, destination, and/or type of one or more of the media streams connecting one or more nodes and/or the hoster.

The topology data may be specific enough, for example, to maintain virtual relationships among the node(s) and the hoster, such as the left camera view from one node being displayed on the right-most display of a second node or on the right-most display of the hoster in embodiments where the hoster includes three display devices. The event focus may not necessarily track the virtual relationships among the various nodes and/or the hoster because those relationships may be considered by the event manager. Consequently, according to some embodiments, the event focus may receive a detailed specification of the event for the nodes and/or the hoster.

With the updated topology data received, the event focus may create directives instructing one or more nodes and/or the hoster to establish the correct media connections and may initialize the selected intent at 250. The event focus may then send the recently created directives to one or more of nodes and/or the hoster that may have been affected by the change in topology for implementation at 252. The event focus may then await reception of further node requests and/or hoster requests at 242.

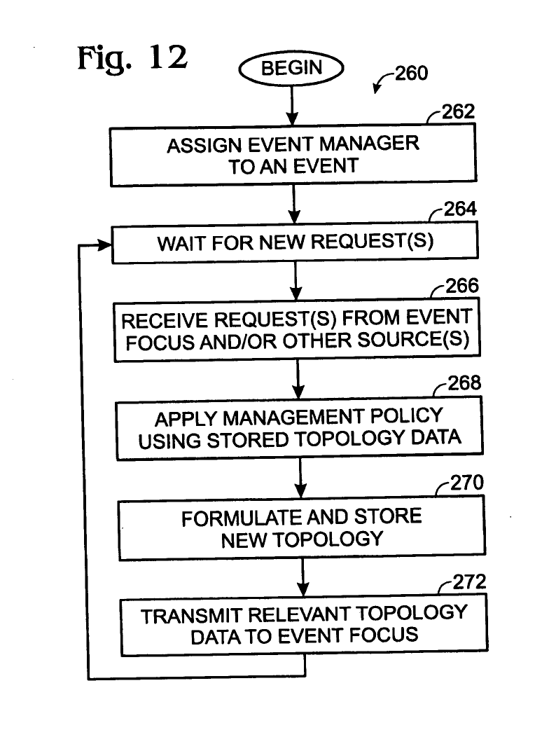

FIG. 12 shows an illustrative method of operation 260 of the event manager upon reception of node requests and/or hoster requests, according to one example. While FIG. 12 shows illustrative steps according to one example, other examples may omit, add to, and/or modify any of the steps shown in FIG. 12. As shown in the illustrative method of FIG. 12, the operation may begin when the event manager is first assigned to at least one event at 262. As mentioned previously, a single event manager may be assigned to any number of events, depending on the capabilities of the specific event manager.

After being assigned to at least one event, the event manager may then wait for requests that will affect the topology of an event that the event manager is assigned to manage at 264. When the event manager receives requests from at least one event focus (or from another client and/or source, such as an administration tool) at 266, the information received may then be stored for later use. Requests may be received from sources such as scheduling applications and/or other support applications.

Specifically, according to some embodiments, the received information may be stored for use in responding to the received request. Based on at least one pre-configured management policy, the event manager may determine the best way to respond to the request at 268. One policy, for example, may use authentication to restrict participation to certain individuals. Another policy may request permission from an already participating node for a new node and/or the hoster to join an event. Another policy may allow as many nodes and the hoster to participate in an event as network bandwidth allows.

After the relevant management policies are applied, the event manager may formulate a new topology and may store the state of the event at 270. According to some embodiments, the event manager may take into account the current topology and additional stored information, such as the prioritized intents of the nodes currently participating in the event and/or the hoster. The event manager may then form the new topology to create and maintain effective virtual relationships among the participating nodes and the hoster. Furthermore, the event manager may take into account varying capabilities of the node(s) and/or the hoster and will not assign media connections that a node and/or the hoster cannot support.

Once the new topology is created, the event manager may transmit the topology data to at least one event focus associated with the event at 272. The topology data may include information specific to one or more nodes and/or the hoster, including one or more media connection assignments and selected intents for one or more nodes and the hoster that communicate with a given event focus. After the topology data has been updated and transmitted, the event manager may return to step 264 to wait for additional requests. One or more of the above illustrative methods, and/or other methods of operation according to this disclosure, may be in the form of computer-executable instructions stored on computer-readable media.

In conclusion, the present illustrative configuration systems and methods are adapted to manage the configuration of virtual collaboration systems. Specifically, the present illustrative method may, among other things, intrinsically consider the relationships among related media streams, manage the virtual relationships among nodes and/or the hoster to optimize the directives to the nodes and/or the hoster to support a new topology, and support a variety of proprietary and industry-standard communications mechanisms while managing one or more nodes and/or the hoster equivalently in the event itself. Further, the present illustrative systems and methods, according to some embodiments, maintain the virtual relationships among node(s) and/or the hoster throughout an event, giving the event a sense of realism while eliminating distractions.

The preceding description has been presented only to show and describe examples of the present illustrative systems and methods. It is not intended to be exhaustive or to limit the systems and methods to any precise form disclosed. Many modifications and variations are possible in light of the above teachings.

What is claimed is:

1. A virtual collaboration system with first media streams, comprising:
a hoster defining at least one simulated node and configured to receive second media streams from at least a second node, and to transmit those streams from the at least one simulated node to at least a first node; and
a management subsystem adapted to dynamically configure a topology of a virtual collaborative event, wherein configuration of the topology includes a determination of media stream connections among the at least one simulated node and the at least a first node based on at least one policy, and wherein the media stream connections establish and maintain virtual relationships among the at least one simulated node and the at least a first node.

2. The system of claim 1, wherein the hoster is further configured to receive the first media streams transmitted from the at least a first node to the at least one simulated node, and to transmit the first media streams to the at least a second node.

3. The system of claim 1, wherein the management subsystem includes a data storage module configured to store topology data describing at least one topology of the virtual collaborative event.

4. The system of claim 3, wherein the topology data includes the capabilities of at least the at least one simulated node and the at least a first node.

5. The system of claim 1, wherein the hoster comprises:
a node generator configured to generate the at least one simulated node;
a manager configured to transmit requests to change a mode of participation of the at least one simulated node;
a first distributor configured to receive the second media streams from the at least a second node, and to transmit the received second media streams from the at least one simulated node to the at least a first node; and
a second distributor configured to receive the first media streams transmitted from the at least a first node to the at least one simulated node, and to transmit the received first media streams to the at least a second node.

6. The system of claim 5, wherein the requests includes at least one of an indication of capabilities and preferred modes of participation of the at least one simulated node.

7. The system of claim 5, wherein the hoster further comprises at least one media device configured to receive and present the received first media streams from the at least a first node, and to generate and transmit hoster media streams to the at least a first node.

8. The system of claim 7, wherein the first distributor is further configured to receive the second media streams from the at least a second node, to transmit the received second media streams to the at least one media device, and to transmit the received second media streams from the at least one simulated node to the at least a first node.

9. The system of claim 8, wherein the second distributor is configured to receive the hoster media streams from the at least one media device, to receive the first media streams transmitted from the at least a first node to the at least one simulated node, and to transmit the received hoster media streams and the received first media streams to the at least a second node.

10. The system of claim 5, wherein the first distributor includes a second compositor configured to form second composite media streams from the received second media streams, and to transmit the second composite media streams from the at least one simulated node to the at least a first node.

11. The system of claim 10, wherein the second distributor includes a first compositor configured to form first composite media streams from the received first media streams, and to transmit the first composite media streams to at least a second node.

12. The system of claim 1, wherein the at least a first node is communicatively coupled to a first network, and the at least a second node is communicatively coupled to a second network having different network characteristics from the first network.

13. The system of claim 12, wherein the at least one simulated node is communicatively coupled to the first network.

14. A method of managing configuration of a topology of a virtual collaborative event involving at least a first node and at least a second node, comprising:
receiving a request from a node of the at least a second node to alter participation in the virtual collaborative event;
generating at least one simulated node;
transmitting the request to alter participation in the virtual collaborative event from the at least one simulated node;
formulating a new topology based on at least one policy, wherein the topology creates and maintains virtual relationships among the at least one simulated node and the at least a first node;
communicating media stream assignments to at least one node affected by the new topology; and
configuring the affected at least one node to establish media streams according to the media stream assignments.

15. The method of claim 14, wherein receiving a request from the node of the at least a second node includes receiving capabilities and preferred modes of participation from the node of the at least a second node.

16. The method of claim 14, wherein generating at least one simulated node includes generating one simulated node for each of the at least a second node.

17. The method of claim 14, wherein communicating media stream assignments includes forming and transmitting individualized directives for the at least one node affected by the new topology.

18. The method of claim 14, wherein configuring the affected at least one node includes receiving first media streams from the at least a first node, forming first composite media stream from the received first media streams, and transmitting the first composite media streams to the at least a second node.

19. The method of claim 18, wherein configuring the affected at least one node includes receiving second media streams from the at least a second node, forming second composite media streams from the received second media streams, and transmitting the second composite media streams from the at least one simulated node to the at least a first node.

20. Computer-readable media comprising computer-executable instructions for managing configuration of a topology of a virtual collaborative event involving at least a first node and at least a second node, the computer-executable instructions, comprising:
receiving a request from a node of the at least a second node to alter participation in the virtual collaborative event;
generating at least one simulated node;
transmitting the request to alter participation in the virtual collaborative event from the at least one simulated node;
formulating a new topology based on at least one policy, wherein the topology creates and maintains virtual relationships among the at least one simulated node and the at least a first node;
communicating media stream assignments to at least one node affected by the new topology; and
configuring the affected at least one node to establish media streams according to the media stream assignments.
